(19) United States
(12) Patent Application Publication
(10) Pub. No.: US 2020/0200953 A1
(43) Pub. Date: Jun. 25, 2020

(54) METHOD OF PRODUCING LENS UNIT AND LENS UNIT

(71) Applicant: OLYMPUS CORPORATION, Tokyo (JP)

(72) Inventor: Kazunari HANANO, Hachioji-shi (JP)

(73) Assignee: OLYMPUS CORPORATION, Tokyo (JP)

(21) Appl. No.: 16/807,316

(22) Filed: Mar. 3, 2020

Related U.S. Application Data
(63) Continuation of application No. PCT/JP2017/032882, filed on Sep. 12, 2017.

(51) Int. Cl. G02B 5/18; G02B 3/00; B29D 11/00; B33Y 10/00; B33Y 80/00; B29C 64/135

(52) U.S. Cl. CPC G02B 5/1814; G02B 3/0031; G02B 5/1842; B29D 11/00403; B29L 2011/0016; B33Y 10/00; B33Y 80/00; B29C 64/135; B29D 11/00769

(57) ABSTRACT

According to an embodiment, a method of producing a lens unit in which lens unit is formed by curing a light-transmitting resin and includes a plurality of lens portions includes: forming, by resin, a first lens portion including a first lens surface and a second lens surface; forming, by resin integrally with first lens portion, a cylindrical support portion extending in a direction parallel to an optical axis direction of first lens portion; forming, by resin integrally with support portion, a second lens portion including a third lens surface facing second lens surface and a fourth lens surface, and having an optical axis coinciding with optical axis of first lens portion; and forming a diffraction grating integrally when any one or more of first lens surface, second lens surface, third lens surface, and fourth lens surface is formed.

### CROSS-REFERENCE TO RELATED APPLICATIONS

This application is a Continuation Application of PCT Application No. PCT/JP2017/032882, filed Sep. 12, 2017, the entire contents of all of which are incorporated herein by reference.

### FIELD

Embodiments of the present invention relate to a method of producing a lens unit, and a lens unit.

### BACKGROUND

A lens unit that forms an image of light on an imaging element includes a plurality of lenses (optical members) and a barrel that holds the lenses. The lens is generally formed by grinding and polishing or molding glass or resin. The barrel is configured with a plurality of members formed by grinding and polishing, and/or molding metal or resin. The lens unit is configured by a combination of plural lenses and a barrel.

For example, Jpn. Pat. Appin. KOKAI Publication No. 2009-83326 discloses the producing method of molding the optical member by discharging and solidifying the thermoplastic resin as droplets based on the shape data of the optical member.

For a 3D printer producing a three-dimensional object based on shape data, materials that can be used are limited. In particular, if an optical member such as a lens is produced, it is required to use a transmissive material in a manner allowing forming a shape with high accuracy. As a method of producing a three-dimensional object with high accuracy, there is a multi-photon polymerization (two-photon polymerization) method. A multi-photon polymerization type 3D printer produces a three-dimensional object by curing a resin by two-photon absorption in which a liquid resin filled in a container is irradiated with light of a predetermined wavelength (laser light).

Further, if a lens unit including a plurality of optical elements is produced as a single unit using the above-noted multi-photon polymerization 3D printer, it is possible to suppress processing errors and assembly errors. However, the multi-photon polymerization method has a problem that it is difficult to produce a lens unit whose chromatic aberration is corrected by differences of multiple materials as in the conventional chromatic aberration correction because optical characteristics of materials that can be used are limited.

### SUMMARY

An object of the present invention is to provide a method of producing an optical element capable of suppressing chromatic aberration and realizing high shape accuracy, and to provide an optical element.

### BRIEF DESCRIPTION OF THE DRAWINGS

FIG. 1 is a diagram for explaining a configuration example of a 3D printer according to an embodiment;

FIG. 2 is a diagram for explaining a configuration example of a lens unit according to an embodiment;

FIG. 3 is an enlarged view showing a part of a lens unit according to an embodiment;

FIG. 4 is a diagram for explaining an example of a manufacturing process of a lens unit according to an embodiment;

FIG. 5 is a diagram for explaining an example of a manufacturing process of a lens unit according to an embodiment;

FIG. 6 is a diagram for explaining an example of a manufacturing process of a lens unit according to an embodiment;

FIG. 7 is a diagram for explaining an example of a manufacturing process of a lens unit according to an embodiment;

FIG. 8 is a diagram for explaining an example of a manufacturing process of a lens unit according to an embodiment;

FIG. 9 is a diagram for explaining an example of a manufacturing process of a lens unit according to an embodiment;

FIG. 10 is a diagram for explaining an example in which an achromat is attached to a lens unit according to an embodiment;

FIG. 11 is a diagram for explaining an example in which an achromat is attached to a lens unit according to an embodiment;

FIG. 12 is a diagram for explaining an example in which a sheath and a glass cover are attached to a lens unit according to an embodiment; and

FIG. 13 is a diagram for explaining an example in which a sheath and a glass cover are attached to a lens unit according to an embodiment.

### DETAILED DESCRIPTION

In the following, with reference to the drawings, a detailed description will be given of a method of producing a lens unit, and a lens unit.

In the present embodiment, a lens unit used for an imaging apparatus is formed by a so-called 3D printer that produces a three-dimensional object based on three-dimensional data (shape data) indicating the shape of the three-dimensional object. Note that the following description will be given taking a multi-photon polymerization type 3D printer as an example of a 3D printer, in which a liquid resin filled in a container is irradiated with light of a predetermined wavelength (laser light) and the resin is cured, thereby forming a three-dimensional object. However, the 3D printer is not limited to a multi-photon polymerization type 3D printer.

The three-dimensional data in the present embodiment is data indicating the shape of the three-dimensional object in a three-dimensional space having a width direction, a depth direction, and a height direction. For example, in a three-dimensional space in which the width direction is represented as an X direction, the depth direction is represented as a Y direction, and the height direction is represented as a Z direction, the three-dimensional data is data indicating existence or non-existence of the structure for each of coordinates defined from the X, Y, and Z directions. The three-dimensional data may be vector data indicating shapes between coordinates determined from the X, Y, and Z directions, in the three-dimensional space. The three-dimensional data may be data obtained by converting data such as 3D-CAD or 3D-CG according to the resolution of the 3D printer.

### First Embodiment

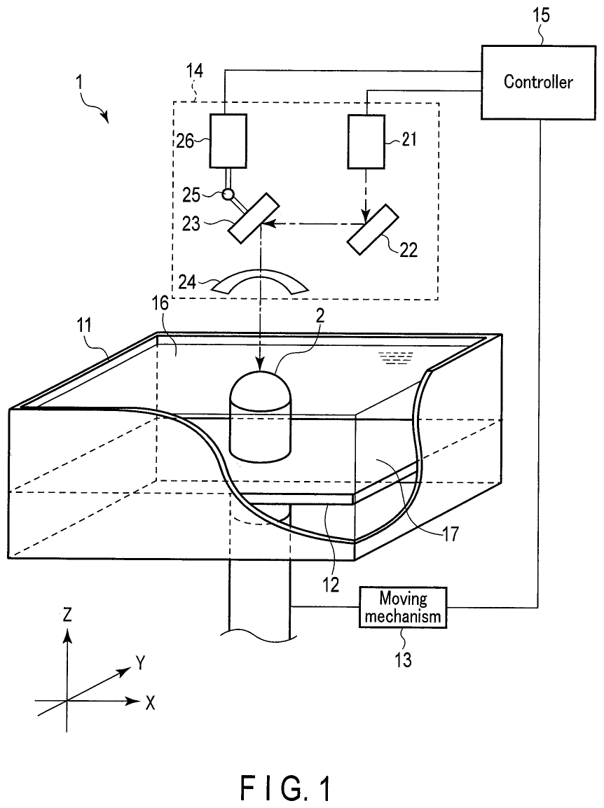

FIG. 1 is an explanatory diagram for explaining an example of a 3D printer 1 according to an embodiment. The 3D printer 1 is a producing apparatus that produces a lens unit 2. The 3D printer 1 produces the lens unit 2 including a plurality of lens portions by curing a light-transmitting resin. The 3D printer 1 produces the lens unit 2 based on, for example, three-dimensional data indicating the shape of the lens unit 2.

First, the configuration of the 3D printer 1 will be described.

The 3D printer 1 includes a container 11, a stage 12, a moving mechanism 13, an exposure device 14, and a controller 15.

The container 11 is a container that holds a liquid resin 16. The liquid resin 16 is a UV-curable photoresist that is cured by laser light emitted from the exposure device 14. For example, the liquid resin 16 absorbs UV light having a wavelength of 390 nm, and is cured when the absorbed energy exceeds a threshold determined by the characteristics of the liquid resin 16. In addition, the liquid resin 16 has an absorption band at a wavelength of 780 nm, and absorbs IR light.

The stage 12 is a stage that supports a three-dimensional object formed by curing the liquid resin 16 with laser light. The stage 12 has a molding surface 17 formed flushly. The stage 12 is disposed in the container 11.

The moving mechanism 13 is a mechanism that moves the stage 12 in the Z direction under the control of the controller 15.

The exposure device 14 is a device that irradiates the liquid resin 16 held in the container 11 with laser light under the control of the controller 15. The exposure device 14 includes a laser light source 21, a first mirror surface member 22, a second mirror surface member 23, a lens 24, a drive mechanism 25, and a drive mechanism controller 26.

The laser light source 21 is a light source that outputs laser light. The laser light source 21 outputs laser light for curing the liquid resin 16 filled in the container 11. The laser light source 21 is configured as an IR laser that outputs IR laser light having a wavelength of 780 nm.

The laser light source 21 may be a device including a laser oscillator that amplifies electromagnetic waves and generates coherent light. The laser light source 21 may be, for example, a laser diode using semiconductor recombination light emission. Further, the laser light source 21 may be configured to further include, for example, an optical fiber amplifier that excites an optical fiber to which a specific rare earth element is added with laser light to thereby generate stimulated emission.

The first mirror surface member 22 is a member having a mirror surface that causes the laser light output from the laser light source 21 to enter the second mirror surface member 23.

The second mirror surface member 23 is a member having a mirror surface that causes the laser light reflected by the first mirror surface member 22 to enter the lens 24.

The lens 24 is a lens that collects the laser light reflected by the second mirror surface member 23 and causes the laser light to enter the liquid resin 16 filled in the container 11. The lens 24 collects the laser light caused to enter the liquid resin 16 with an intensity at which the liquid resin 16 is cured.

The drive mechanism 25 is a mechanism that drives the second mirror surface member 23 to change the position and angle of the mirror surface of the second mirror surface member 23. The drive mechanism 25 changes the position and angle of the mirror surface of the second mirror surface member 23 in accordance with the control of the drive mechanism controller 26.

The drive mechanism controller 26 controls the drive mechanism 25 to change the position and angle of the mirror surface of the second mirror surface member 23. Thereby, the drive mechanism controller 26 changes the position, where the laser light reflected by the mirror surface of the second mirror surface member 23 enters the liquid resin 16, in the X and Y directions.

The controller 15 acquires three-dimensional data indicating the structure of the lens unit 2, and controls the operations of the moving mechanism 13 and the exposure unit 14 based on the acquired three-dimensional data. The controller 15 includes a central processing unit (CPU), a read only memory (ROM), a random access memory (RAM), a communication interface, and the like. The CPU is an arithmetic element (for example, a processor) that executes arithmetic processing. The ROM is a read-only nonvolatile memory. The RAM is a volatile memory functioning as a working memory. The communication interface is an interface that communicates with another device. The CPU acquires three-dimensional data from other devices via the communication interface. Further, the controller 15 realizes various functions by the CPU executing programs in the ROM. The controller 15 analyzes the three-dimensional data, and controls the moving mechanism 13 and the exposure unit 14 based on the result of analysis.

Next, an operation of the 3D printer 1 will be described.

The controller 15 recognizes the structure of the lens unit 2 layer-by-layer based on the three-dimensional data. For example, the controller 15 recognizes the existence or non-existence of the structure of the three-dimensional object in the X and Y directions for each coordinate in the Z direction of the three-dimensional data. The controller 15 controls the moving mechanism 13 and the exposure device 14 so as to form a structure of the three-dimensional object using one Z-direction coordinate as one layer.

When starting the formation of the lens unit 2, the controller 15 first adjusts the height of the stage 12. For example, the controller 15 controls the moving mechanism 13 to move the molding surface 17 of the stage 12 to a position lower by a predetermined distance from the interface of the liquid resin 16 filled in the container 11. Specifically, the controller 15 controls the moving mechanism 13 to move the molding surface 17 of the stage 12 to a position lower by a predetermined distance from the interface of the liquid resin 16 filled in the container 11.

The controller 15 controls the exposure device 14 to irradiate the liquid resin 16 with laser light, cure the liquid resin 16, and form a three-dimensional object. The controller 15 recognizes the existence or non-existence of the structure of the lens unit 2 for each coordinate defined from the X and Y directions in one layer (e.g., the first layer is a layer corresponding to the Z-direction coordinate=0). The controller 15 controls the exposure unit 14 to cause the laser light to enter the position corresponding to the coordinate in which the existence of the structure of the laser unit 2 has been determined, on the interface of the liquid resin 16. In this manner, the controller 15 forms the one-layer lens unit 2 according to three-dimensional data.

After forming the one-layer lens unit 2, the controller 15 controls the moving mechanism 13 to move the stage 12 in a direction in which the molding surface 17 of the stage 12 is away from the interface of the liquid resin 16 filled in the container 11. For example, the controller 15 moves the stage 12 in the Z direction by one-layer height of the lens unit 2.

The controller 15 forms the structure of the lens unit 2 of the next layer (layer adjacent to the layer for which the structure was formed immediately before). That is, in the next layer, the controller 15 recognizes the existence or non-existence of the structure of the lens unit 2 for each coordinate determined from the X and Y directions. The controller 15 controls the exposure unit 14 to cause the laser light to enter the position corresponding to the coordinate in which the existence of the structure of the laser unit 2 has been determined, on the interface of the liquid resin 16. In this manner, the controller 15 stacks the structure of the next layer on the structure of the previous layer of the lens unit 2. The controller 15 alternately and repeatedly executes the movement of the stage 12 by the moving mechanism 13 and the irradiation of the interface of the liquid resin 16 with the laser beam by the exposure device 14, thereby producing the lens unit 2 according to the three-dimensional data.

Next, the lens unit 2 produced by the 3D printer 1 will be described.

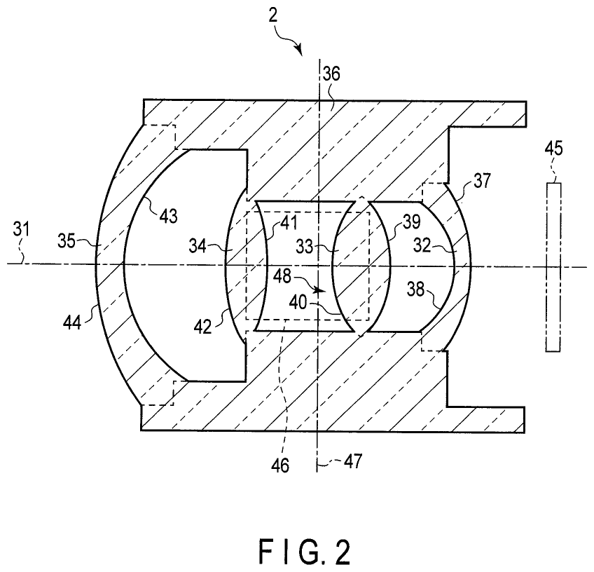

FIG. 2 is an explanatory diagram for explaining a configuration example of the lens unit 2 produced by the 3D printer 1 described above. FIG. 2 shows a cross-sectional view of the lens unit 2 cut along a plane parallel to an optical axis 31 of the lens unit 2.

The lens unit 2 includes a plurality of lens portions that function as a lens, and a support portion that supports the lens portions. For example, the lens unit 2 includes a first lens portion 32, a second lens portion 33, a third lens portion 34, and a fourth lens portion 35, functioning as a lens. The lens unit 2 includes a support portion 36 that supports the first lens portion 32, the second lens portion 33, the third lens portion 34, and the fourth lens portion 35. The first lens portion 32, the second lens portion 33, the third lens portion 34, the fourth lens portion 35, and the support portion 36 are integrally formed. The lens unit 2 in FIG. 2 is a four-group lens unit having four lens portions, but the number of lens portions may not be four. For example, the lens unit 2 may be a five-group lens unit having five lens portions.

The first lens portion 32 is a concave lens having a first lens surface 37 and a second lens surface 38. The first lens surface 37 faces an imaging element 45 on which a subject image is formed by the lens unit 2. The second lens surface 38 is provided on the opposite side of the first lens surface 37.

The second lens portion 33 is a convex lens having a third lens surface 39 and a fourth lens surface 40. The third lens surface 39 faces the second lens surface 38. The fourth lens surface 40 is provided on the opposite side of the third lens surface 39.

The third lens portion 34 is a convex lens having a fifth lens surface 41 and a sixth lens surface 42. The fifth lens surface 41 faces the fourth lens surface 40. The sixth lens surface 42 is provided on the opposite side of the fifth lens surface 41.

The fourth lens portion 35 is a concave lens having a seventh lens surface 43 and an eighth lens surface 44. The seventh lens surface 43 faces the sixth lens surface 42. The eighth lens surface 44 is provided on the opposite side of the seventh lens surface 43.

The support portion 36 is formed in a cylindrical shape extending in a direction parallel to the optical axis direction of the plurality of lens portions. The support portion 36 is integrally formed of the same resin as the first lens portion 32, the second lens portion 33, the third lens portion 34, and the fourth lens portion 35.

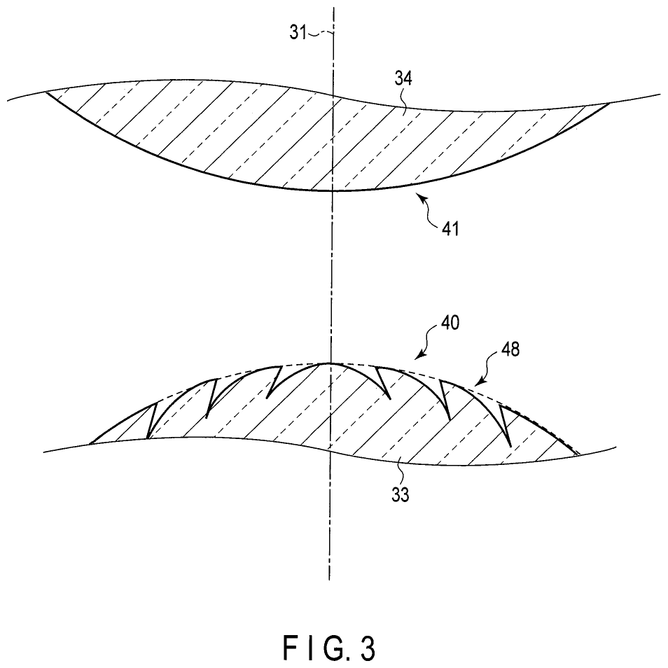

FIG. 3 is an enlarged view of the fourth lens surface 40 of the second lens portion 33 and the fifth lens surface 41 of the third lens portion 34 shown as a region 46 in FIG. 2. As shown in FIG. 3, the fourth lens surface 40 is formed to have undulations the depth of which is about the wavelength of light. The undulations of the fourth lens surface 40 are formed concentrically with the optical axis of the second lens portion 33 as the center. Furthermore, multiple undulations of the fourth lens surface 40 are formed at different distances from the optical axis of the second lens portion 33 so as to form a substantially convex surface as a whole, and they constitute a diffraction grating 48. That is, the diffraction grating 48 has a structure in which a plurality of undulations formed from the fourth lens surface 40 in an axisymmetric shape around the optical axis 31 are formed at intervals in the radiation direction (meridional direction) of the fourth lens surface 40. The undulations of the diffraction grating 48 are formed integrally with the second lens portion 33 when the fourth lens surface 40 is formed. According to such a configuration, a diffraction phenomenon occurs in which light emitted from the fifth lens surface 41 and incident on the fourth lens surface 40 is diffracted by the diffraction grating 48.

According to the light refraction phenomenon, the light with short wavelength easily bends, whereas according to the diffraction phenomenon, the light with long wavelength easily bends. Therefore, the diffraction phenomenon can bend the light in a direction in which the chromatic dispersion caused by the refraction phenomenon is canceled. That is, the second lens portion 33 diffracts the light emitted from the fifth lens surface 41 facing the fourth lens surface 40 provided with the diffraction grating 48, and causes the light to enter the fourth lens surface 40, thereby functioning as a diffractive optical element that corrects chromatic aberration caused by a refraction phenomenon on another lens surface.

The lens unit 2 is formed so that the optical axes of the first lens portion 32, the second lens portion 33, the third lens portion 34, and the fourth lens portion 35 coincide. That is, the first lens portion 32, the second lens portion 33, the third lens portion 34, and the fourth lens portion 35 of the lens unit 2 are formed in an axially symmetric shape with the optical axis 31 as the center, and function as a complex lens that forms a subject image on the imaging surface of the imaging element 45. Further, the pupil position (aperture position) as a complex lens of the first lens portion 32, the second lens portion 33, the third lens portion 34, and the fourth lens portion 35 is the pupil position 47 in FIG. 2.

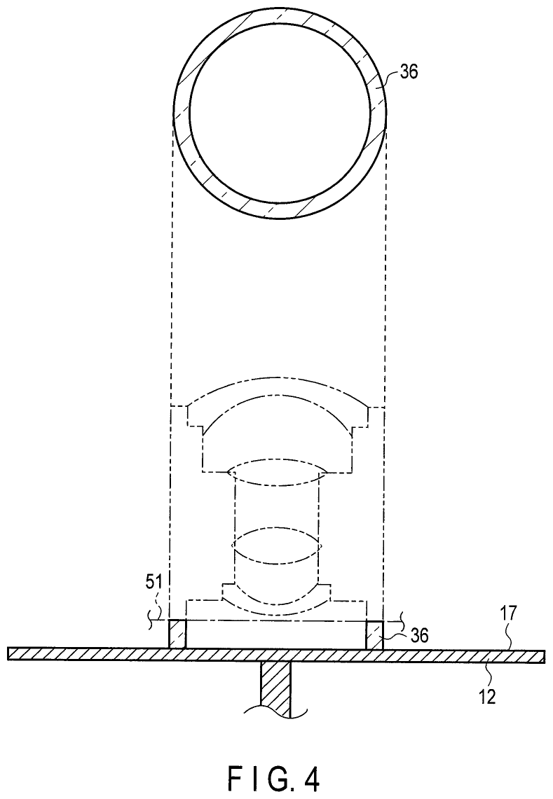

Next, with reference to FIGS. 4 to 9, a description will be given of a manufacturing process of the lens unit 2 shown in FIGS. 2 and 3 by the 3D printer 1. In the lens unit 2 while being pointed at a subject, a site close to the subject is referred to as a front end side of the lens unit 2, whereas a site close to an image is referred to as a rear end side. In the present embodiment, an example in which the lens unit 2 is produced by sequentially stacking three-dimensional objects from the rear end side will be described. FIGS. 4 to 9 show a cross-sectional view through a plane parallel to the optical axis 31 of the lens unit 2 during its production, and a view of the lens unit 2 as viewed from the direction facing the stage 12 during the production. FIGS. 4 to 9 show the interface of the liquid resin 16 as an interface 51.

FIG. 4 is an explanatory diagram for explaining a process of forming a part of the support portion 36 of the lens unit 2 by curing the liquid resin 16. The 3D printer 1 forms the structure of the lens unit 2 from the rear end side on the molding surface 17 of the stage 12. Thus, the 3D printer 1 first controls the exposure device 14, and scans with laser light in a circular manner along a surface orthogonal to the optical axis of the lens unit 2 (surface parallel to the molding surface 17), thereby forming a part of the support portion 36 of the lens unit 2 in a cylindrical shape.

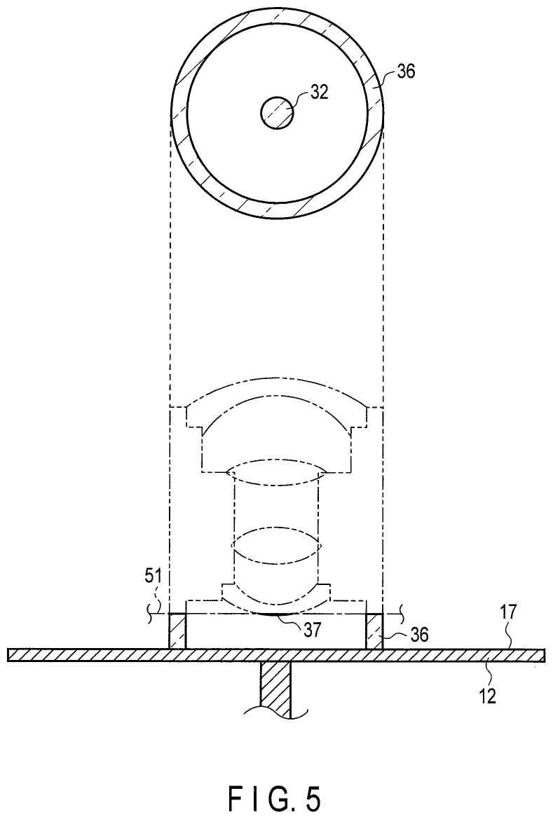

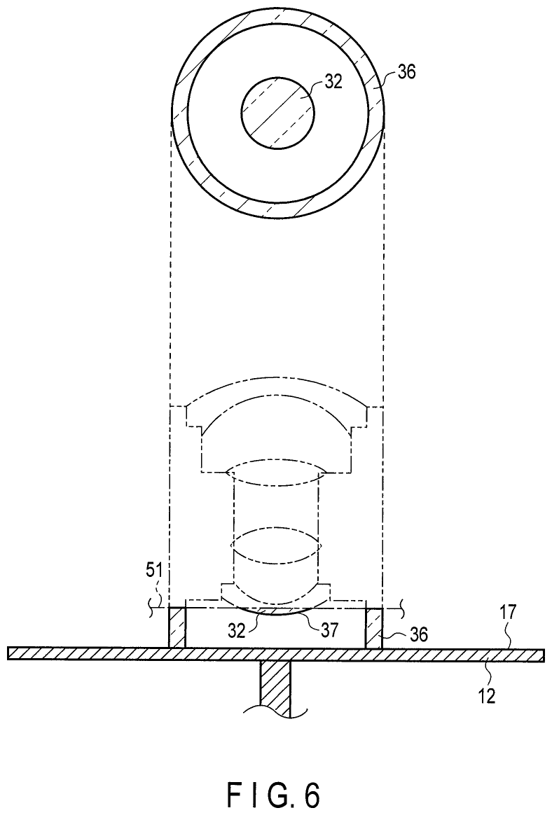

FIGS. 5 and 6 are explanatory views for explaining a process of forming a part of the support portion 36 and the first lens portion 32 of the lens unit 2. As shown in FIG. 5, if the structure of the first lens portion 32 is included in the layer in which the three-dimensional object is formed, similarly to the support portion 36, the 3D printer 1 forms the structure of the first lens portion 32 from the rear end side (the first lens surface 37 side). As shown in FIG. 6, the 3D printer 1 proceeds with formation of the structure of the first lens portion 32.

If the structure of the three-dimensional object is formed at a position away from the molding surface 17 of the stage 12 in the Z direction, the structure of the three-dimensional object is formed in the liquid resin 16, and after the formation, a liquid drain hole (not shown) is provided in the support portion 36 to drain the liquid resin. Further, the structure of the three-dimensional object at a position away from the molding surface 17 of the stage 12 in the Z direction may be supported by a support member (support material) that supports the structure of the three-dimensional object. The specific gravity of the liquid resin 16 hardly changes between the liquid state and the curing state. Therefore, it is possible to form a three-dimensional object in a floating state in the liquid resin 16. When a support material is used, the 3D printer 1 may be configured to simultaneously form a support material having a predetermined shape. The 3D printer 1 may be configured in such a manner that the liquid resin 16 in the container 11 is replaced with a different liquid resin and the support material is formed by a different material. In this case, by forming the support material using a water-soluble liquid resin and providing a hole (not shown) in the support portion 36, the support material dissolved in water can be removed from the lens unit 2.

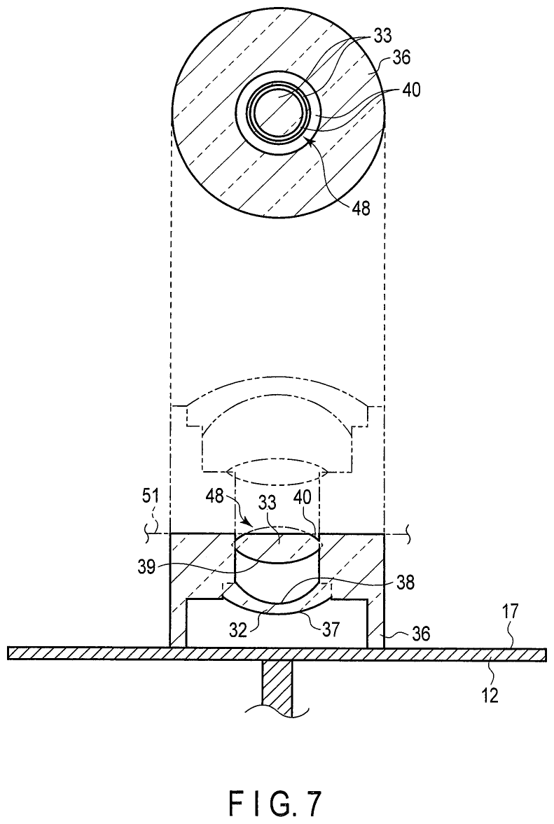

FIG. 7 is an explanatory diagram for explaining a process of forming the support portion 36 of the lens unit 2 and the fourth lens surface 40 of the second lens portion 33. The 3D printer 1 proceeds with the formation of the structure of the lens unit 2 to form the second lens portion 33. Further, when forming the fourth lens surface 40 of the second lens portion 33, the 3D printer 1 forms a plurality of undulations concentrically as shown in FIG. 3.

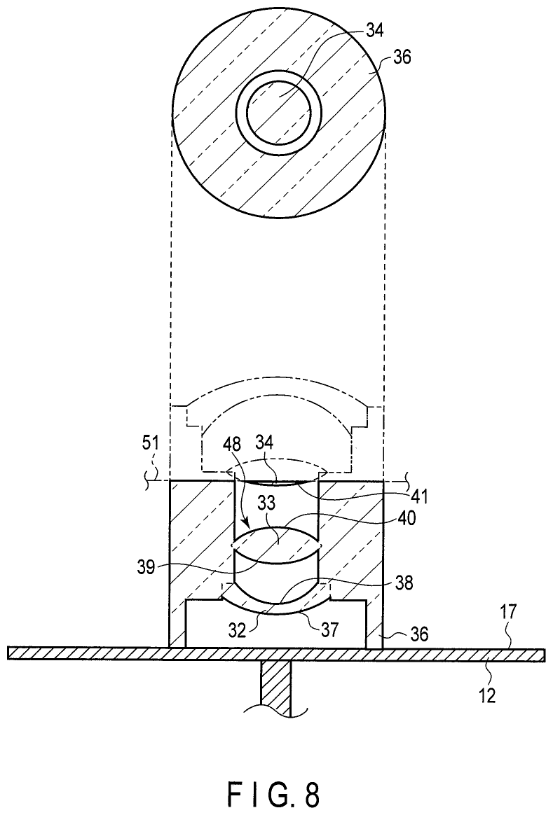

FIG. 8 is an explanatory diagram for explaining a process of forming the support portion 36 and the fifth lens surface 41 of the third lens portion 34 of the lens unit 2. The 3D printer 1 proceeds with the formation of the structure of the lens unit 2 to form the third lens portion 34.

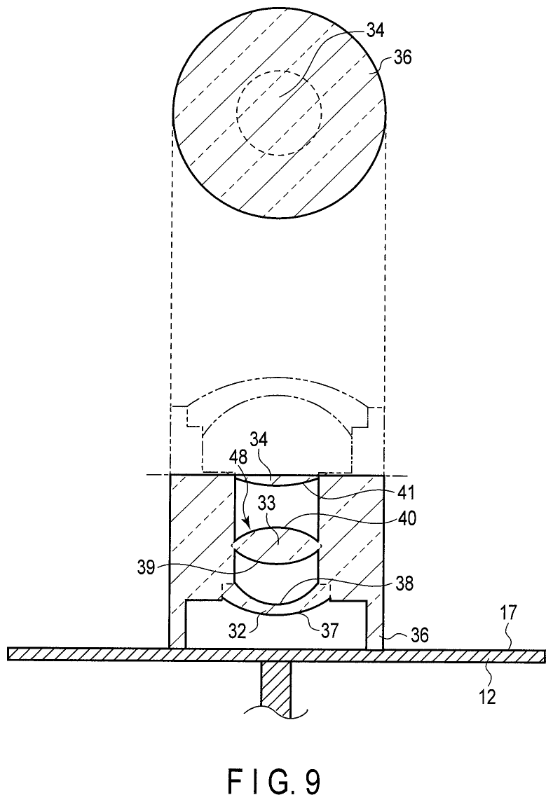

FIG. 9 is an explanatory diagram for explaining a process of forming a part of the support portion 36 and the third lens portion 34 of the lens unit 2. The 3D printer 1 proceeds with the formation of the structure of the lens unit 2, continuing the formation up to the position where the third lens portion 34 and the support portion 36 are connected. At this time, when the lens unit 2 is viewed from the Z direction, the third lens portion 34 and the support portion 36 are integrally formed as shown in FIG. 9.

According to the configuration as described above, the 3D printer 1 can integrally form the lens unit 2 including the plurality of lens portions and the support portion 36 that supports the plurality of lens portions. Therefore, the 3D printer 1 can suppress processing errors and assembly errors when the lens unit 2 is produced.

The purpose of normal chromatic aberration correction is to correct chromatic dispersion caused by refraction. Thus, it is general to adopt a method of reducing chromatic dispersion of a complex lens of a plurality of lenses by causing a reverse chromatic dispersion by an achromatic lens combining a concave lens of a high dispersion material and a convex lens of a low dispersion material. However, according to the above-described configuration, the 3D printer 1 can form the second lens portion 33 having the fourth lens surface 40 on which the diffraction grating 48 for correcting chromatic aberration caused by refraction phenomenon is formed, and other lenses integrally in the lens unit 2. Thus, the 3D printer 1 can produce the lens unit 2 capable of correcting chromatic aberration without using a high dispersion material and a low dispersion material. Therefore, the 3D printer 1 can realize simplification of the assembly of the lens unit 2 and compactness of the size of the lens unit 2.

In addition, the pupil position 47 in the complex lens of the first lens portion 32, the second lens portion 33, the third lens portion 34, and the fourth lens portion 35 is a position where the difference in the light flux passage area depending on the angle of view is smaller than other positions. In the lens unit 2 shown in FIG. 2, a fourth lens surface 40 having a diffraction grating 48 formed at a position close to the pupil position 47 is formed. Thereby, it is possible to correct the axial chromatic aberration in a priority manner.

In the embodiment described above, the lens unit 2 has been described as having a configuration in which the diffraction grating 48 is provided on the fourth lens surface 40, but the lens unit 2 is not limited to this configuration. The lens unit 2 may be configured in such a manner that the diffraction grating 48 is provided not on the fourth lens surface 40, but on another lens surface such as the first lens surface 37, the second lens surface 38, the third lens surface 39, the fourth lens surface 40, the fifth lens surface 41, the sixth lens surface 42, the seventh lens surface 43, or the eighth lens surface 44.

For example, it may be provided on the fourth lens portion 35 that is closest to the subject. This makes it possible to preferentially correct the chromatic aberration of magnification. Note that in order to avoid damage to the shape of the diffraction grating 48, it is desirable that the diffraction grating 48 be provided on the seventh lens surface 43 of the fourth lens portion 35. In other words, it is desirable that the diffraction grating 48 be provided on the lens surface facing another lens surface.

The lens unit 2 may be configured in such a manner that the diffraction grating 48 is provided on a plurality of lens surfaces. That is, the lens unit 2 may be configured in such a manner that the diffraction grating 48 is provided on plural lens surfaces of the first lens surface 37, the second lens surface 38, the third lens surface 39, the fourth lens surface 40, the fifth lens surface 41, the sixth lens surface 42, the seventh lens surface 43, and the eighth lens surface 44.

In the above embodiment, it has been described that the 3D printer 1 produces the lens unit 2 including the lens surface on which the diffraction grating 48 is formed, but the present invention is not limited to this configuration. The 3D printer 1 may have any configuration as long as it produces the lens unit 2 including a shape that requires accuracy in relative position with respect to another lens surface.

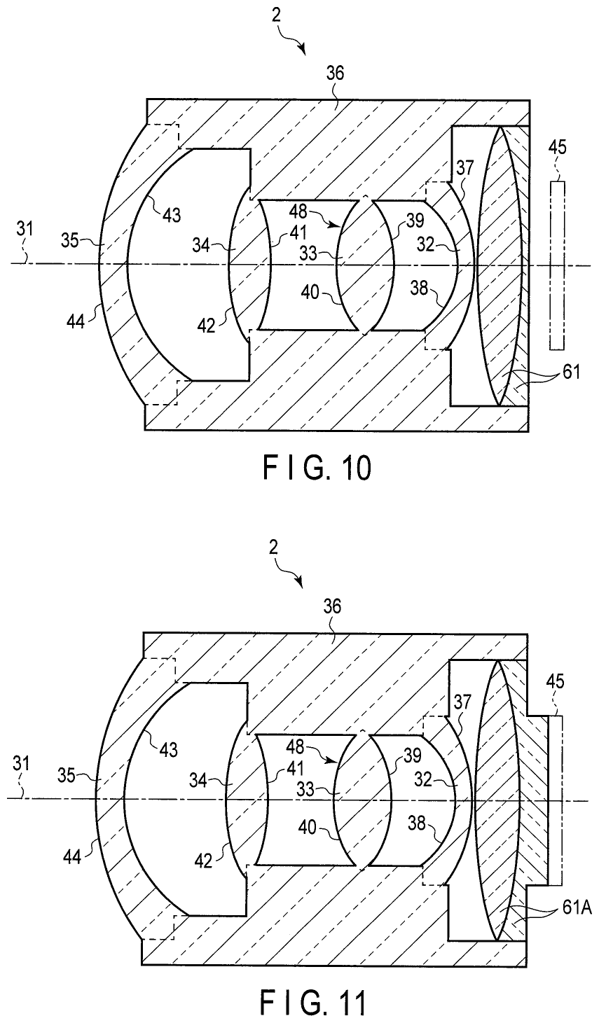

Further, another lens may be combined with the support portion 36 of the lens unit 2 produced by the above method. FIGS. 10 and 11 show an example in which an achromatic lens (or an apochromatic lens) is combined with the support portion 36 of the lens unit 2.

FIG. 10 shows an example in which the achromat 61 is fitted to the support portion 36 of the lens unit 2 on the rear end side with respect to the first lens portion 32. The achromat 61 is a correction lens for correcting chromatic aberration by a concave-convex two-type lens with different dispersion. For example, the achromat 61 corrects chromatic aberration caused by the complex lens of the first lens portion 32, the second lens portion 33, the third lens portion 34, and the fourth lens portion 35.

FIG. 11 shows an example of an achromat 61A that is fitted to the support portion 36 of the lens unit 2 on the rear end side with respect to the first lens portion 32 and serves as a centered lens of the imaging element 45. The achromat 61A is a correction lens that corrects chromatic aberration. For example, the achromat 61A corrects chromatic aberration caused by the complex lens of the first lens portion 32, the second lens portion 33, the third lens portion 34, and the fourth lens portion 35.

According to such a configuration, the chromatic aberration can be corrected by both the diffractive optical element provided in the lens unit 2, and the achromat 61. Thus, the chromatic aberration residue not corrected by the diffractive optical element can be corrected by the achromat 61. Furthermore, since the correction amount can be dispersed to the achromat 61 and the diffractive optical element, it is possible to realize an improvement in the degree of freedom in selecting materials of the achromat 61, and an improvement in the degree of freedom in designing the diffractive optical element.

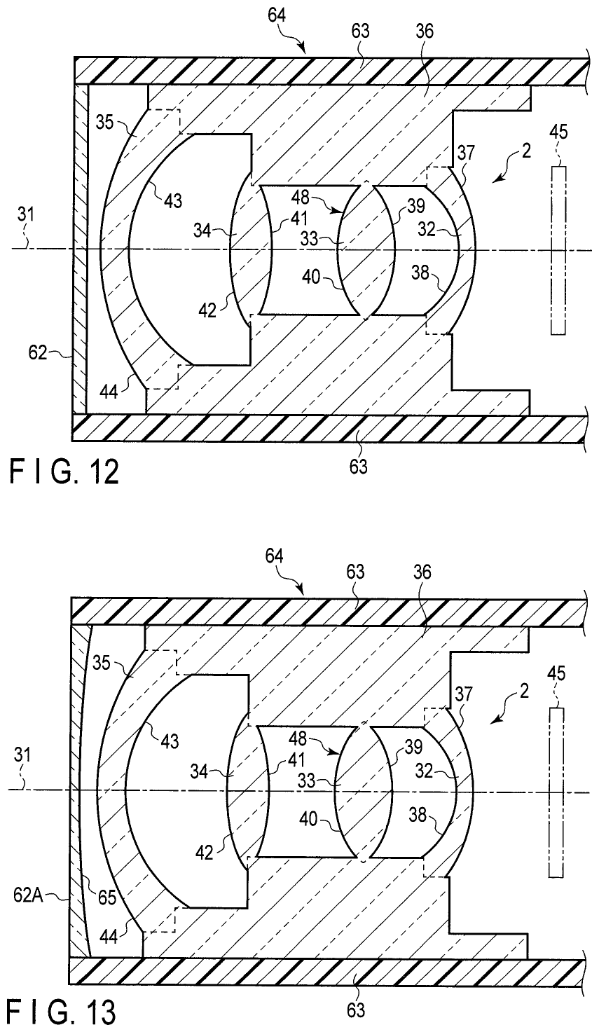

Further, the lens unit 2 produced by the above-described method may be combined with a cover glass 62 and a sheath 63. FIG. 12 shows an example in which the lens unit 2 is combined with a cover glass 62 and a sheath 63, and configured as an endoscope camera head 64. The camera head 64 includes the lens unit 2, the sheath 63, and the cover glass 62. The camera head 64 is configured in such a manner that the lens unit 2 is provided in the sheath 63 together with the imaging element 45 and sealed with the cover glass 62.

The sheath 63 is an outer sheath that covers the lens unit 2. The sheath 63 prevents the lens unit 2, the imaging element 45, and wiring, etc. connected to the imaging element 45 from being exposed.

The cover glass 62 is a transmissive member that seals the end of the sheath 63. The cover glass 62 seals the end of the sheath 63 on the front end side of the lens unit 2. Thus, the sheath 63 and the cover glass 62 can prevent the lens unit 2 and the imaging element 45 from being damaged or immersed.

As described above, the endoscope camera head 64 can be configured by combining the lens unit 2, the cover glass 62, and the sheath 63 of FIG. 2.

In addition, as shown in FIG. 13, a cover glass 62A having a ninth lens surface 65 may be used instead of the cover glass 62. Furthermore, the cover glass 62A may be configured as an optical element that reduces chromatic aberration caused by the complex lens of the first lens portion 32, the second lens portion 33, the third lens portion 34, and the fourth lens portion 35.

According to such a configuration, it is possible to configure an endoscope camera head 64 capable of correcting chromatic aberration by both the diffractive optical element included in the lens unit 2 and the cover glass configured as an element having an achromatic function.

The present invention is not limited to the above-described embodiments, and various modifications can be made as appropriate in practice without departing from the gist the invention. In addition, the embodiments may be appropriately combined as much as possible, and in that case, a combined effect can be obtained. Further, the above embodiments include inventions at various stages, and various inventions may be extracted by appropriately combining a plurality of constituent elements disclosed above. For example, even if some constituent elements are deleted from all the constituent elements shown in the embodiment, the problem described in the section of the problem to be solved by the invention can be solved, and the effect described in the section of the effect of the invention can be obtained.

1. A method of producing a lens unit, the lens unit formed by curing a light-transmitting resin and including a plurality of lens portions, the method comprising:
forming, by the resin, a first lens portion including a first lens surface and a second lens surface;
forming, by the resin integrally with the first lens portion, a cylindrical support portion extending in a direction parallel to an optical axis direction of the first lens portion;
forming, by the resin integrally with the support portion, a second lens portion including a third lens surface facing the second lens surface and a fourth lens surface, and having an optical axis coinciding with the optical axis of the first lens portion; and
forming a diffraction grating integrally when any one or more of the first lens surface, the second lens surface, the third lens surface, and the fourth lens surface is formed.

2. The method according to claim 1, wherein the forming the diffraction grating forms the diffraction grating on the second lens surface or the third lens surface.

3. The method according to claim 1, wherein the forming the diffraction grating forms the diffraction grating on a lens surface closest to a pupil position of a complex lens of the first lens portion and the second lens portion.

4. The method according to claim 1, wherein the forming the diffraction grating forms the diffraction grating on a lens surface closest to a subject among lens surfaces facing another lens surface.

5. The method according to claim 1, wherein the forming the first lens portion, the forming the support portion, and the forming the second lens portion form the first lens portion, the support portion, and the second lens portion integrally, by curing a liquid resin by irradiating the liquid resin with light while moving a stage in a container filled with the liquid resin and scanning the light along a surface orthogonal to optical axes of the first lens portion or the second lens portion.

6. The method according to claim 1, wherein the forming the diffraction grating forms the diffraction grating by forming a plurality of undulations undulated from a lens surface in an axially symmetric shape about an optical axis at intervals in a radiation direction.

7. The method according to claim 1, wherein the forming the diffraction grating forms a diffraction grating that corrects chromatic aberration caused by a refraction phenomenon on another lens surface by diffracting light emitted from a lens surface facing a lens surface provided with the diffraction grating and causing the light to enter the lens surface provided with the diffraction grating.

8. A lens unit formed by curing a light-transmitting resin, comprising:
a first lens portion formed by the resin and including a first lens surface and a second lens surface;
a cylindrical support portion formed by the resin integrally with the first lens portion and extending in a direction parallel to an optical axis direction of the first lens portion;
a second lens portion formed by the resin integrally with the support portion, including a third lens surface facing the second lens surface and a fourth lens surface, and having an optical axis coinciding with the optical axis of the first lens portion; and
a diffraction grating formed integrally when any one or more of the first lens surface, the second lens surface, the third lens surface, and the fourth lens surface is formed.

9. The lens unit according to claim 8, wherein the diffraction grating is formed on the second lens surface or the third lens surface.

10. The lens unit according to claim 8, wherein the diffraction grating is formed on a lens surface closest to a pupil position of a complex lens of the first lens portion and the second lens portion.

11. The lens unit according to claim 8, wherein the diffraction grating is formed on a lens surface closest to a subject among lens surfaces facing another lens surface.
